(19) United States
(12) Patent Application Publication
(10) Pub. No.: US 2005/0230039 A1
(43) Pub. Date: Oct. 20, 2005

(54) Stent with protective pads or bulges

(76) Inventors: Michael Austin, Tuam (IE); Aiden Flanagan, Kilcolgan (IE); Barry O'Brien, Barna (IE)

Correspondence Address: JONES DAY, 222 EAST 41ST ST, NEW YORK, NY, 10017, US

(21) Appl. No.: 10/828,021

(22) Filed: Apr. 19, 2004

(51) Int. Cl. B32B 31/00

(52) U.S. Cl. 156/272.8; 156/280

(57) ABSTRACT

A stent having at least one strut comprising at least one pad or bulge is disclosed. The pads or bulges are of a height that are preferably slightly greater than the thickness of a coating that can be disposed on the strut. The coating is not disposed on the pads. When the stent is placed within a delivery member such as a sheath or a catheter, the pads or bulges contact the inner surface of the delivery member, preventing the coating from contacting the inner surface. Damage to the coating that may be caused by friction with or adhesion to the delivery member is thus prevented. Methods for forming such a stent are also discussed.

### FIELD OF THE INVENTION

This invention pertains to stents. More specifically, this invention pertains to stents that comprise at least one strut having at least one pad or bulge and a coating comprising a therapeutic substance.

### BACKGROUND OF THE INVENTION

The use of stents to aid in the prevention of restenosis (the narrowing of a blood vessel following the removal or reduction of a previous narrowing) is well known.

Stents for preventing restenosis generally have an expanded state and an contracted state. Stents are generally delivered intra-luminally to the treatment area in their contracted state. The stent is then expanded so that its outer surface contacts or presses against the wall of the blood vessel. Stents typically fall into one of two categories. Balloon-expandable stents rely upon contracting and forcefully crimping a stent around the wrapped balloon portion of a balloon catheter. An outer delivery sheath is then passed over the crimped stent and balloon assembly, which after intra-luminal displacement, is pulled back and the balloon inflated to expand the stent. During expansion, the stent undergoes a permanent deformation, so that upon removal of the balloon, the stent remains in its expanded state. When the balloon-expandable stent is delivered to the target area, a sheath or other delivery member may be placed around the balloon-expandable stent, which comes into contact with the outer surface of the stent. In contrast, self-expanding stents are composed of elastic material. In their contracted state, self-expanding stents are similar to compressed springs, in that the body of the stent in its compressed state exerts a constant force to expand outwardly. To deliver a self-expanding stent to the treatment area, the stent is compressed and loaded into a sheath or other delivery member. The stent, through its outer surfaces, exerts a continuous force against the walls of the delivery member, but is prevented from expanding by the delivery member. When the stent is released from the delivery member at the treatment area, the stent is free to expand until the sides of the stent press against the blood vessel's walls.

It has been recently determined that coating the outer surfaces of a stent with a therapeutic substance increases the effectiveness of the stent in preventing restenosis. However, a difficulty often arises, especially when self-expanding stents are coated with therapeutic substances. These coatings, which are often polymer based, are generally soft and tacky, and have a tendency to adhere to surfaces they come into contact with. As discussed above, a sheath or delivery member may be placed around the stent. The sheath or delivery member can come into contact with the outer surface of the coated stent. Since the coating is often tacky, friction or adhesion may occur between the sheath or delivery device and the outer surface of the coated stent. This friction or adhesion can cause damage to the coating. For example, low-grade adhesion of the coating to the delivery member may cause the coating to peel away from the stent as the stent is released from the delivery member at the target area. This is especially possible with self-expanding stents because the outer surface of a self-expanding stent is usually pressed against the inner surface of its delivery member. In addition to the loss of the benefits of the coating at the target area, it is highly undesirable to have loose pieces of the coating circulating through the body of the patient.

Therefore, there is a need for a stent that provides a way to protect the coating of a stent from interaction with a delivery member. A method of manufacturing such a stent is also needed.

### SUMMARY OF THE INVENTION

The present invention addresses the above stated difficulties by disclosing a method of manufacturing a stent that has a plurality of pads on the outer surface of the stent. The pads have outer surfaces or bearing surfaces that can contact the sheath or delivery member. The bearing surfaces are not coated. Also, the pads have a height that preferably is slightly greater than the thickness of a coating that is applied to the outer surface of the stent. Thus, when the stent is loaded into a delivery member such as a catheter or a sheath, the inner wall of the delivery member is in contact only with the bearing or outer surfaces of the pads, and not the coating. This prevents the coating from being damaged by interaction with the delivery member.

The present invention also teaches methods for manufacturing these stents with the required precision. Preferred embodiments use lasers to cut, weld, and shape the parts used to form the finished stent.

In a preferred embodiment, a method of making a stent having at least one strut having an outer surface, and at least one pad that projects from the outer surface of the strut comprises (a) obtaining a tube having an outer surface, wherein the tube comprises a tube material; (b) connecting at least one pad-forming component having an inner surface to the outer surface of the tube, wherein the pad-forming component comprises a component material; and (c) removing a portion of the tube material from the tube to form the strut, wherein the at least one pad-forming component forms the at least one pad. The method may further comprise the step of removing a portion of the component material from the pad forming component to form the pad. The steps of removing the portion of the tube material and removing the portion of the pad-forming material may be conducted simultaneously. The pad-forming component may be connected to the tube by welding the inner surface of the pad-forming component to the outer surface of the tube. The welding may be conducted by using a laser. The tube may be a cylindrical tube. The bearing surface may be rounded.

The method may further comprise the step of disposing a therapeutic coating on the outer surface of the strut. The method may also further comprise the step of disposing the therapeutic coating on the bearing surface of the pad. The pad may comprise a height and the coating disposed on the outer surface of the strut may comprise a thickness, wherein the pad height is greater than the thickness of the coating disposed on the outer surface of the strut. The method may further comprise the step of removing the coating from the bearing surface. The coating may be removed from the bearing surface by laser ablation. The coating may comprise paclitaxel.

The pad-forming component may comprise a ring. The ring may comprise a triangular cross-section. The ring may comprise a plurality of nodes and connectors. The method may further comprise the step of shaping the bearing surface with a laser. The pad-forming component may also comprise a helix.

In another preferred embodiment, a method of making a stent comprising at least one strut having an inner surface and an outer surface, wherein the strut comprises at least one pad that projects from at least one of the inner surface or the outer surface of the strut comprises (a) obtaining a tube having an inner surface, an outer surface, and at least one pad-forming projection integral with and projecting from at least one of the tube inner surface or the tube outer surface; and (b) forming the strut comprising the pad projecting from at least one of the inner surface or outer surface of the strut, wherein the pad comprises a bearing surface. The pad may project from the outer surface of the strut. The strut may be formed by removing material from the tube with a laser.

The method may further comprise the step of disposing a therapeutic coating on a surface of the strut from which the pad projects. The method may further comprise the step of disposing the therapeutic coating on the bearing surface of the pad. The pad may comprise a height and the coating disposed on the surface of the strut may comprise a thickness, wherein the pad height is greater than the thickness of the coating disposed on the surface of the strut.

The method may further comprise the step of removing the coating from the bearing surface. The coating may be removed from the bearing surface by laser ablation. The coating may comprise paclitaxel. The pad-forming projection may be disposed along the longitudinal axis of the tube.

In another preferred embodiment, a method of making a stent comprising at least one strut having an inner surface and an outer surface, wherein the strut comprises at least one strut bulge that projects towards at least one of the inner surface or the outer surface of the strut comprises (a) obtaining a tube having a tubular wall comprising an inner surface and an outer surface, a first end, a second end and a lumen therein; (b) deforming the tubular wall to form at least one tubular wall bulge extending towards at least one of the tubular wall inner surface or the tubular wall outer surface; and (c) forming the strut comprising the strut bulge, wherein the strut bulge is at least a portion of the tubular wall bulge and wherein the strut bulge comprises a bearing surface. The tubular wall may be deformed by using a mold to form the tubular wall bulge. The tube may also be deformed by placing the tube into the mold which comprises a wall having a contour and exerting a force on the tubular wall to conform the tubular wall to the contour of the mold wall. The force may be applied to the first end of the tube in a direction parallel to the longitudinal axis of the tube. The force may be applied to the tubular wall by increasing the pressure within the lumen of the tube.

The strut may formed by removing material from the tube with a laser. The method may also further comprise the step of disposing a therapeutic coating on a surface of the strut towards which the bulge projects. The method may also further comprise the step of disposing the therapeutic coating on the bearing surface of the bulge. The bulge may comprise a height and the coating disposed on the surface of the strut may comprise a thickness, wherein the bulge height is greater than the thickness of the coating disposed on the surface of the strut.

The method may further comprise the step of removing the coating from the bearing surface. The coating may be removed from the bearing surface by laser ablation. The coating may comprise paclitaxel.

### BRIEF DESCRIPTION OF THE DRAWINGS

FIG. 1 is a perspective view of a stent formed in accordance with a method of the present invention.

FIG. 2 is schematic cross-sectional view of a stent within a delivery member.

FIG. 3 is a schematic partial cross-sectional view of a stent within a delivery member.

FIGS. 4A and 4B are front and side views, respectively, of a tube used in a preferred embodiment of the present invention.

FIGS. 5A and 5B are front and side views, respectively, of a ring used in a preferred embodiment of the present invention.

FIG. 6 is front view of ring used in another preferred embodiment of the present invention.

FIG. 7 is a side view of a ring used in yet another preferred embodiment of the present invention.

FIGS. 8A and 8B are front and side views, respectively, of a ring used in yet another preferred embodiment of the present invention.

FIG. 9 is a side view of a tube and a helix or helical ribbon used in another preferred embodiment of the present invention.

FIG. 10 is a side view of tube in a mold according to another embodiment of the present invention.

FIG. 11 is a front view of a tube in a mold according to another embodiment of the present invention.

FIG. 12 is a top view of a mold according to another embodiment of the present invention.

FIG. 13 is a partial cross sectional view of a stent strut that has been formed according to another embodiment of the present invention.

FIG. 14 is a schematic partial cross-sectional view of the stent of FIG. 3 within a blood vessel.

FIG. 15 is a side view of a tube with as struts are being formed in the tube according to a preferred embodiment of the present invention.

FIG. 16 is a side view of a strut and pad formed according to another embodiment of the present invention.

FIG. 17 is a partial side view of a stent formed according to another embodiment of the present invention.

### DETAILED DESCRIPTION OF THE INVENTION

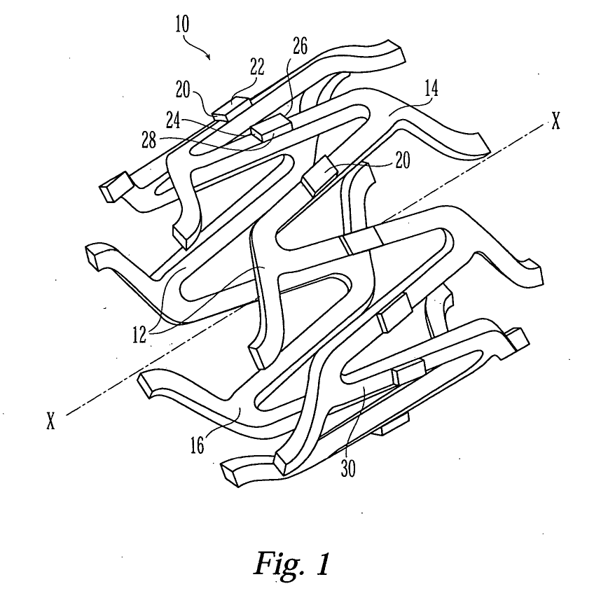

FIG. 1 illustrates stent 10 comprising a plurality of interconnected struts 12. Each strut 12 has outer surface 14, inner surface 16, and stent 10 has longitudinal axis X. Outer surface 14 of strut 12 comes in direct contact with body tissue when stent 10 is placed in the target area. Inner surface 16 of strut 12 is the surface opposite outer surface 14 of the strut 10. Disposed along the outer surface 14 of at least one strut 12 is at least one, but preferably a plurality of pads 20, each pad 20 having a bearing surface 22. The bearing surface or outer surfaces of the pad is the surface that comes in direct contact with a sheath or delivery device disposed about the stent. The bearing surface of the pad may also directly contacts the body tissue when the stent is delivered to the target area. A therapeutic coating 30 may be disposed on outer surface 14 of strut 12, but not on bearing surface 22 of the pads 20.

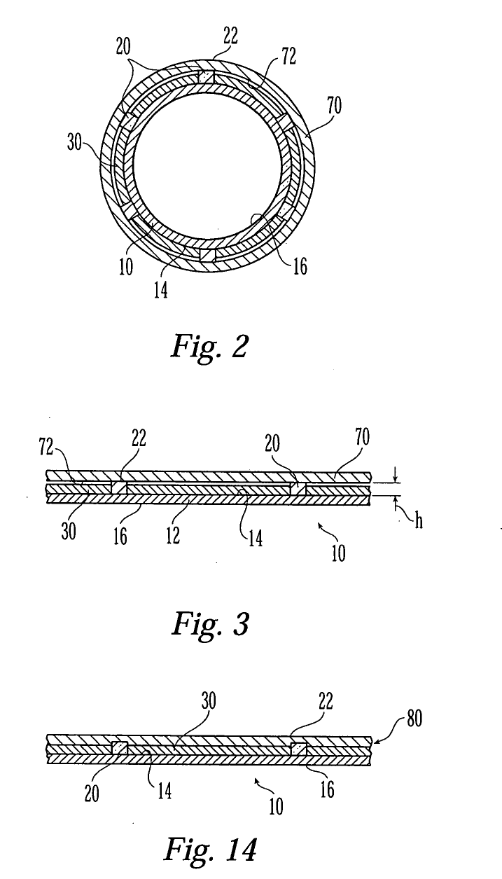

FIGS. 2 and 3 shows stent 10 loaded into delivery member 70. Height h of pads 20 is slightly greater than the thickness of coating 30. Thus, only bearing surfaces 22 of pads 20 contact inner surface 72 of delivery member 70. Inner wall 72 is stiff enough to prevent pads 20 from penetrating into inner wall 72. Thus, coating 30 may be prevented from contacting inner wall 72.

When stent 10 is delivered by and released from delivery member 70 into the target area of the blood vessel being treated, stent 10 expands until outer surface 14 of struts 12 presses against vessel wall 80, as shown in FIG. 14. In contrast to inner wall 72 of delivery member 70, vessel wall 80 may be pliant enough to allow pads 20 sink into vessel wall 80 as stent 10 expands until coating 30 comes into direct contact with vessel wall 80. This direct contact may allow coating 30 to effectively deliver its therapeutic substances to vessel wall 80. This also may allow pads 20 to aid in anchoring stent 10 within vessel wall 80, preventing migration of stent 10 away from the target area.

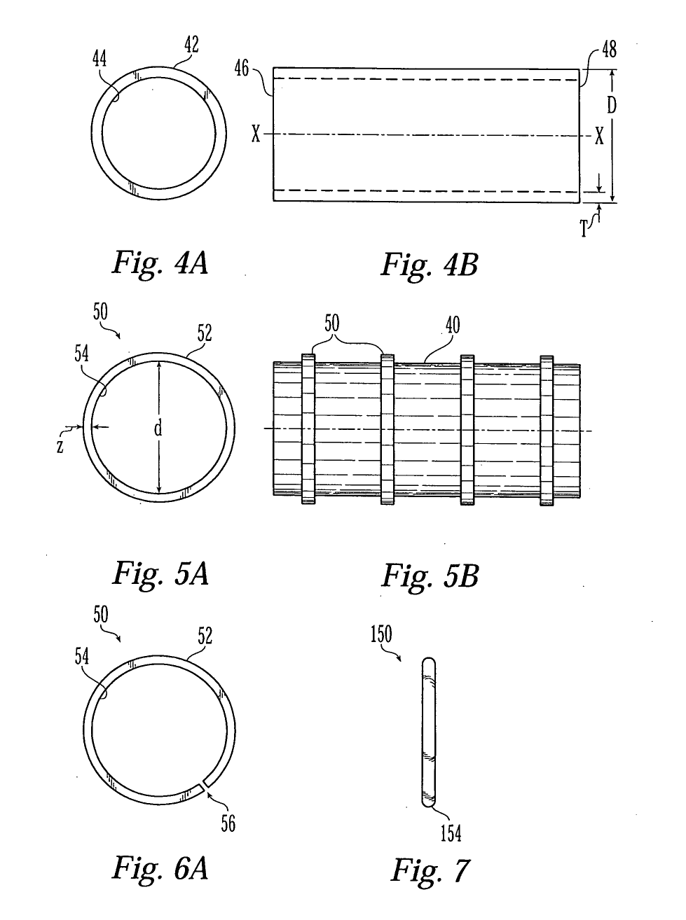

In an exemplary method of manufacturing stent 10 according to the present invention, cylindrical tube 40, as shown in FIGS. 4A and 4B, is formed from a suitable material. However, it is to be understood that tube 40 need not be cylindrical in cross-section along longitudinal axis X. For example, tube 40 may be triangular or rectangular in cross-section. Tube 40 may be formed by a “drawn tube” or “cold drawing” process, which is well known. A tube formed by such a process may be formed with thin walls that are seamless and have a precise thickness. However, it is to be understood that other methods of forming tube 40, such as casting, molding, grinding, or turning, may also be used. Tube 40 comprises outer surface 42, inner surface 44, first end 46, second end 48, and longitudinal axis X. Tube 40 has outer diameter D and wall thickness T, corresponding to the desired thickness of struts 12 and the outer diameter of stent 10 (not including the thickness of pads 20) in its maximum expanded state.

Next, a pad-forming component used to form pads 20 is formed. In an exemplary embodiment, the pad-forming component may be a plurality of rings 50. As shown in FIGS. 5A and 5B, rings 50 generally comprise outer surface 52, inner surface 54, thickness t, and inner diameter d. Rings 50 may be continuous with inner diameter d that is slightly greater than outer diameter D of tube 40, allowing rings 50 to be slipped over tube 40 while allowing the entire inner surface 54 to be in surface-to-surface contact with outer surface 42 of tube 40, as shown in FIGS. 5A and 5B. In a preferred embodiment, rings 50 may be formed by cutting a tube similar to tube 40 (but having a thickness t and inner diameter d) along a plane transverse to its longitudinal axis.

Alternatively, as shown in FIG. 6, each ring 50 may be cut transversely at one point along their circumference. This allows rings 50 to expand slightly while being slipped over tube 40. Rings 50 would then exert a mild force against outer surface 42, thus ensuring surface-to-surface contact between outer surface 42 of tube 40 and inner surface 54 of ring 50. In addition, this embodiment of rings 50 eliminates the possibility of either not having ring 50 fit over tube 40 or not having the entire surface of inner surface 52 contacting outer surface 42 of tube 40.

Rings or pad-forming components 50 are then connected, by welding for example, to tube 40 along a plurality of locations on ring or pad-forming component 50 using a laser. Component 50 may also be welded to tube 40 along its entire circumference or length. In particular, an Nd:YAG laser may be used. Methods other than welding can be used to connect the pad-forming component to the tube. One of skill in the art would be aware of such methods. As shown in FIG. 15, a laser may then be used to cut material from tube 40 and rings or pad-forming components 50 so that struts 12 are formed, with the portions of rings 50 that remain forming pads 20.

In connecting or welding rings or pad-forming components 50 to tube 40, care should be taken to locate the connections or welds where pads 20 will eventually be located on struts 12. Otherwise, the portions of rings 50 that are supposed to form pads 20 may fall away when struts 12 are cut out of tube 40. Each tube 40 should be fixed in relation to a holder until all welds and cuts are completed. However, should tube 40 need to be moved between the welding of rings 50 and the cutting of tube 40 to form struts 12, it is important that tube 40 be properly oriented before struts 12 are cut.

At each location, ring 50 should be welded along a width that is slightly greater than that of pad 20, ensuring that the entirety of pad 20 will be welded to strut 12. Rings 50 should also be welded with an equal linear space between each ring 50.

Tube 40 may be formed from self-expanding materials such as nitinol, Elgiloy, or other such materials. Balloon-expandable stents (i.e. non-self-expanding) may be formed from, e.g., stainless steel, platinum, alloys of niobium, alloys of tantalum, and PERSS (platinum enriched stainless steel). Rings or pad forming components 50 may be formed from the same material or a different material than tube 40. For example, pads 20 may be formed of a radiopaque material such as tungsten or alloys of platinum, tantalum, or niobium. Pads 20 may then be used as markers to assist in properly positioning stent 10 during delivery.

Once stent 10 is formed, a coating can be disposed on the struts. The entire outer surface 14 of stent 10 may be coated with coating 30, including bearing surfaces 22 of pads 20 as well as the struts 12. Coating 30 may be applied to stent 10 by spraying. This method is preferred because it provides greater control over the amount of coating 30 applied to stent 10 (and therefore the thickness of the coating on the stent). Other methods of applying coating 30 include dip coating, electrostatic spraying, inkjet coating, ultrasonic nozzle, fluidized bed, and brush-on methods. Typically, the thickness of coating 30 is between 10 and 20 microns. The thickness of coating 30 should be less than height h of pads 20.

The coating that is disposed on stent 10 may be polymer based, and may further comprise biologically active materials and/or genetic materials. Polymer(s) useful for forming the porous coating layer should be ones that are biostable, biocompatible, particularly during insertion or implantation of the device into the body and avoids irritation to body tissue. Examples of such polymers include, but not limited to, polyurethanes, polyisobutylene and its copolymers, silicones, and polyesters. Other suitable polymers include polyolefins, polyisobutylene, ethylene-alphaolefin copolymers, acrylic polymers and copolymers, vinyl halide polymers and copolymers such as polyvinyl chloride, polyvinyl ethers such as polyvinyl methyl ether, polyvinylidene halides such as polyvinylidene fluoride and polyvinylidene chloride, polyacrylonitrile, polyvinyl ketones, polyvinyl aromatics such as polystyrene, polyvinyl esters such as polyvinyl acetate; copolymers of vinyl monomers, copolymers of vinyl monomers and olefins such as ethylene-methyl methacrylate copolymers, acrylonitrile-styrene copolymers, ABS resins, ethylene-vinyl acetate copolymers, polyamides such as Nylon 66 and polycaprolactone, alkyd resins, polycarbonates, polyoxyethylenes, polyimides, polyethers, epoxy resins, polyurethanes, rayon-triacetate, cellulose, cellulose acetate, cellulose butyrate, cellulose acetate butyrate, cellophane, cellulose nitrate, cellulose propionate, cellulose ethers, carboxymethyl cellulose, collagens, chitins, polylactic acid, polyglycolic acid, and polylactic acid-polyethylene oxide copolymers. Since the polymer is being applied to a part of the medical device which undergoes mechanical challenges, e.g. expansion and contraction, the polymers are preferably selected from elastomeric polymers such as silicones (e.g. polysiloxanes and substituted polysiloxanes), polyurethanes, thermoplastic elastomers, ethylene vinyl acetate copolymers, polyolefin elastomers, and EPDM rubbers. The polymer is selected to allow the coating to better adhere to the surface of the expandable portion of the medical device when it is subjected to forces or stress. Furthermore, although the porous coating layer can be formed by using a single type of polymer, various combinations of polymers can be employed.

Biologically active materials may include anti-proliferative drugs such as steroids, vitamins, and restenosis-inhibiting agents. Preferred restenosis-inhibiting agents include microtubule stabilizing agents such as Taxol or paclitaxel, which includes paclitaxel analogues, derivatives, and mixtures thereof. For example, derivatives suitable for use in the present invention include 2′-succinyl-taxol, 2′-succinyl-taxol triethanolamine, 2′-glutaryl-taxol, 2′-glutaryl-taxol triethanolamine salt, 2′-O-ester with N-(dimethylaminoethyl) glutamine, and 2′-O-ester with N-(dimethylaminoethyl) glutamide hydrochloride salt. Other preferred biologically active materials include nitroglycerin, nitrous oxides, nitric oxides, antibiotics, aspirins, digitalis, estrogen derivatives such as estradiol and glycosides.

Biologically active material may also include non-genetic therapeutic agents, such as: anti-thrombogenic agents such as heparin, heparin derivatives, urokinase, and PPack (dextrophenylalanine proline arginine chloromethylketone); anti-proliferative agents such as enoxaprin, angiopeptin, or monoclonal antibodies capable of blocking smooth muscle cell proliferation, hirudin, acetylsalicylic acid, tacrolimus, everolimus, amlodipine and doxazosin; anti-inflammatory agents such as glucocorticoids, betamethasone, dexamethasone, prednisolone, corticosterone, budesonide, estrogen, sulfasalazine, rosiglitazone, mycophenolic acid and mesalamine; antineoplastic/antiproliferative/anti-miotic agents such as paclitaxel, 5-fluorouracil, cisplatin, vinblastine, vincristine, epothilones, methotrexate, azathioprine, adriamycin and mutamycin; endostatin, angiostatin and thymidine kinase inhibitors, cladribine, taxol and its analogs or derivatives; anesthetic agents such as lidocaine, bupivacaine, and ropivacaine; anti-coagulants such as D-Phe-Pro-Arg chloromethyl keton, an RGD peptide-containing compound, heparin, antithrombin compounds, platelet receptor antagonists, anti-thrombin anticodies, anti-platelet receptor antibodies, aspirin (aspirin is also classified as an analgesic, antipyretic and anti-inflammatory drug), dipyridamole, protamine, hirudin, prostaglandin inhibitors, platelet inhibitors, antiplatelet agents such as trapidil or liprostin and tick antiplatelet peptides; DNA demethylating drugs such as 5-azacytidine, which is also categorized as a RNA or DNA metabolite that inhibit cell growth and induce apoptosis in certain cancer cells; vascular cell growth promoters such as growth factors, Vascular Endothelial Growth Factors (FEGF, all types including VEGF-2), growth factor receptors, transcriptional activators, and translational promoters; vascular cell growth inhibitors such as antiproliferative agents, growth factor inhibitors, growth factor receptor antagonists, transcriptional repressors, translational repressors, replication inhibitors, inhibitory antibodies, antibodies directed against growth factors, bifunctional molecules consisting of a growth factor and a cytotoxin, bifunctional molecules consisting of an antibody and a cytotoxin; cholesterol-lowering agents; vasodilating agents; and agents which interfere with endogenous vasoactive mechanisms; anti-oxidants, such as probucol; antibiotic agents, such as penicillin, cefoxitin, oxacillin, tobranycin, rapamycin (sirolimus); angiogenic substances, such as acidic and basic fibroblast growth factors, estrogen including estradiol (E2), estriol (E3) and 17-Beta Estradiol; and drugs for heart failure, such as digoxin, beta-blockers, angiotensin-converting enzyme (ACE) inhibitors including captopril and enalopril, statins and related compounds.

The genetic materials mean DNA or RNA, including, without limitation, of DNA/RNA encoding a useful protein stated below, intended to be inserted into a human body including viral vectors and non-viral vectors as well as anti-sense nucleic acid molecules such as DNA, RNA and RNAi. Viral vectors include adenoviruses, gutted adenoviruses, adeno-associated virus, retroviruses, alpha virus (Semliki Forest, Sindbis, etc.), lentiviruses, herpes simplex virus, ex vivo modified cells (e.g., stem cells, fibroblasts, myoblasts, satellite cells, pericytes, cardiomyocytes, skeletal myocytes, macrophage), replication competent viruses (e.g., ONYX-015), and hybrid vectors. Non-viral vectors include artificial chromosomes and mini-chromosomes, plasmid DNA vectors (e.g., pCOR), cationic polymers (e.g., polyethyleneimine, polyethyleneimine (PEI)) graft copolymers (e.g., polyether-PEI and polyethylene oxide-PEI), neutral polymers PVP, SP1017 (SUPRATEK), lipids or lipoplexes, nanoparticles and microparticles with and without targeting sequences such as the protein transduction domain (PTD). The biological materials include cells, yeasts, bacteria, proteins, peptides, cytokines and hormones. Examples for peptides and proteins include growth factors (FGF, FGF-1, FGF-2, VEGF, Endotherial Mitogenic Growth Factors, and epidermal growth factors, transforming growth factor and platelet derived endothelial growth factor, platelet derived growth factor, tumor necrosis factor, hepatocyte growth factor and insulin like growth factor), transcription factors, proteinkinases, CD inhibitors, thymidine kinase, monoclonal antibodies, and bone morphogenic proteins (BMP's), such as BMP-2, BMP-3, BMP-4, BMP-5, BMP-6 (Vgr-1), BMP-7 (OP-1), BMP-8. BMP-9, BMP-10, BMP-11, BMP-12, BMP-13, BMP-14, BMP-15, and BMP-16. Currently preferred BMP's are BMP-2, BMP-3, BMP-4, BMP-5, BMP-6, BMP-7. These dimeric proteins can be provided as homodimers, heterodimers, or combinations thereof, alone or together with other molecules. Cells can be of human origin (autologous or allogeneic) or from an animal source (xenogeneic), genetically engineered, if desired, to deliver proteins of interest at the transplant site. The delivery media can be formulated as needed to maintain cell function and viability. Cells include whole bone marrow, bone marrow derived mono-nuclear cells, progenitor cells (e.g., endothelial progentitor cells) stem cells (e.g., mesenchymal, hematopoietic, neuronal), pluripotent stem cells, fibroblasts, macrophage, and satellite cells.

After coating, a laser may then be used to ablate coating 30 from bearing surface 22 of each pad 20, further described in patent application WO/03039768, herein incorporated by reference. Removing coating 30 from bearing surfaces 22 prevents coating 30 from being adhering to or otherwise interacting with inner wall 72 of sheath or delivery member 70 when stent 10 is compressed and loaded into delivery member 70. Depending upon the size and geometry of the laser beam, the laser may be scanned over the pad 20 or the beam may be shaped to conform to the geometry of pad 20. The laser may ablate coating 30 from the entire bearing surface 22 of pad 20, as well as a small portion of coating 30 on strut 12 that is adjacent to pad 20. This should ensure that coating 30 is entirely removed from pad 20. This also should prevent an edge of coating 30 from snagging and peeling away during deployment from the delivery catheter.

While coating 30 may be removed by mechanical methods such as grinding, such methods may produce waste particles that may become embedded within coating 30 on struts 12. The precision and speed that can be achieved by using lasers in welding and cutting may make them the preferred tools for producing stents according to the present invention. Also, as discussed above, the use of lasers may also minimize the production of waste particles during the manufacturing process.

As shown in FIG. 1, the shape of pads 20 that are formed from the process described above are dependent upon the orientation of the particular strut 12 that pad 20 is disposed on. In general, however, pads 20 formed using this process will generally have front and rear surfaces 24, 26 that are transverse to the longitudinal axis X of stent 10, with side surfaces 28 that conform with the orientation of side surfaces of struts 12. It may be preferable to have pads 20 that are of a different overall shape and orientation. It may also be preferable to have pads 20 with a rounded surface. This would reduce friction between pads 20 and inner surface 72 of delivery member 70. A laser may be used to slightly melt pads 50, either during welding or during ablating.

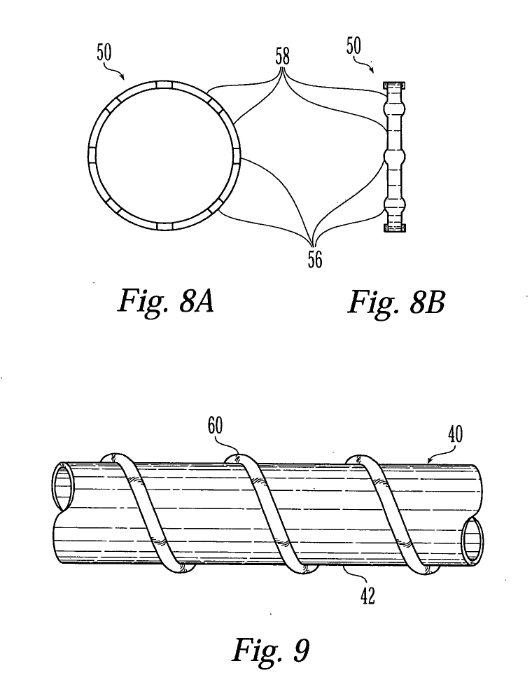

In another embodiment, rings 50 may be formed to have a rounded outer surface 54, as shown in FIG. 7. Alternatively, as illustrated in FIGS. 8A and 8B, rings 50 may be formed as a plurality of nodes 56 connected by links or connectors 58. Rings 50 may be welded to tube 40 at each node 56. Links 58 may then be cut away as stent 10 is cut from tube 40. Using this method, the preferred shapes for pads 50 may be easily formed. Furthermore, by reducing the size of links 58, the waste material generated when the laser cuts away the discardable portions of rings 50 is reduced.

It is to be appreciated that the pad-forming component from which pads 20 are formed may have shapes other than rings 50. For example, the pad-forming component may be a helix or helical ribbon 60. As shown in FIG. 9, ribbon 60 may be slipped around the outer surface of tube 40 in a manner similar to rings 50 as described above. The same welding and cutting steps of the above method may then be used. The use of ribbon 60 reduces the number of parts that must be positioned and attached to tube 40.

One skilled in the art will appreciate that a stent may be formed with at least one pad 20 being disposed on the inner surface 16 of at least one strut 12, as illustrated in FIG. 17. Bearing surfaces 22 of pads 20 would prevent contact with a coating 30 disposed on inner surface 16 with, for example, a balloon catheter 200 used to expand the stent 10. To form pads 20, a method similar to the one described above may be used, with pad-forming elements 50 being connected to the inner surface 44 of tube 40. Pad forming elements used in this embodiment would be configured to fit within the lumen of tube 40.

In an alternative embodiment, pad forming components 50 or pads 20 are connected to stent 10 after struts 12 are cut out of tube 40. Preferably, a laser is used to weld pads 20 or pad/forming components to the outer surface 14 or inner surface 16 of struts 12.

In another embodiment, tube 40 is formed with a plurality of pad-forming projections 100 that project from inner surface 44 and/or outer surface 42, with pad-forming projections 100 running parallel to longitudinal axis X. Tube 40 may be formed by cold drawing. Struts 12 may then be formed or cut out of tube 40, with pads 20 being formed from pad-forming projections 100. As can be readily appreciated, this method has the advantage of eliminating several steps of the previously described methods of manufacture, which entailed the precise positioning of numerous elements (rings 50) and welds or connections. Pad-forming projections 100 may be formed to have a variety of profiles, which correspond to different shapes for pads 20. However, because the cold-drawing process requires that tube 40 have the same cross-section along its longitudinal axis X, the final shape, location, and orientation of pads 20 may be more restricted than in stents 10 formed from the previously described methods.

If cold-drawing is not used to form tube 40, then tube 40 may be formed with pad-forming projections that have a wider variety of shapes. For example, tube 40 may be cast in a mold having a plurality of cavities, with each cavity corresponding to a pad 20. However, other types of processes may not be able to provide tubes 40 with the same precise tolerances as cold drawing.

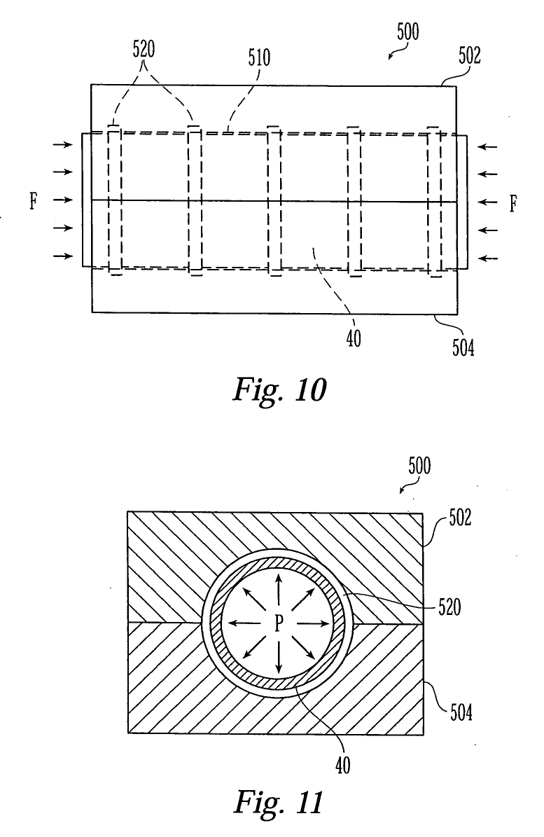

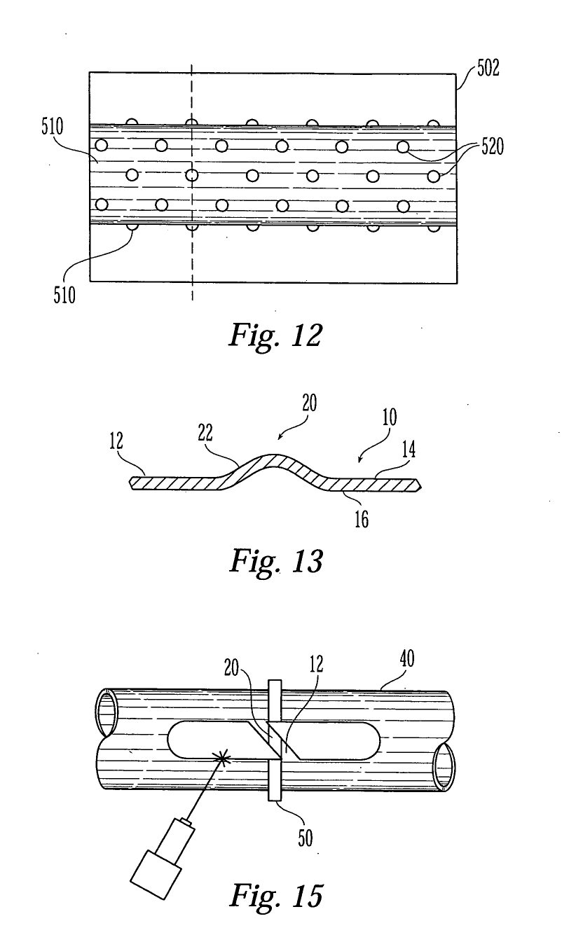

Another method of the present invention involves the use of struts having bulges instead of pads. A tube 40 is subjected to forces that selectively deform the wall of tube 40 to form tubular wall bulges 100. A mold 500 may be used to aid in the deformation process. As shown in FIG. 10, mold 500 may have two halves 502 and 504, allowing mold 500 to separate to allow for the insertion and/or removal of tube 40. Mold 500 has a cavity 510 that is contoured to match the desired profile of bulged tube 40 after the deformation process is complete. Cavity 510 may further comprise sub-cavities 520.

In a first embodiment of this method, axial pressure is exerted on the ends of tube 40 that has been placed in cavity 510 of mold 500. Tube 40 thus deforms so that walls contour to the profile of cavity 510, forming tubular wall bulges 100. Struts 12 may then be cut out of tube 40, with the portions of tubular wall bulges 100 that remain forming strut bulges 20 (see FIG. 13).

In a second embodiment, tube 40 is placed in a mold 500 with cavities 510. Cavity 510 may further comprise sub-cavities 520. The internal pressure within the tube lumen is then raised to a level sufficient to deform the outer wall of tube 40 outwardly to conform to the contour of cavity 510. This method may allow cavity 510 and sub-cavities 520 to take on a wider variety of geometries, which in turn allows tubular wall bulge 20 to have different shapes, placements, and configurations. For example, this method may be used to form ring-like tubular wall bulges from which strut bulges 20 are formed once struts 12 are cut from tube 40, or it may be used to form tubular wall bulges that are already configured into the proper shape of strut bulges 20.

It is to be appreciated that the present invention also encompasses methods, similar to the ones described above, in which a stent having pads or bulges on the inner surfaces of the stent struts can be formed from a tube having projections or tubular strut bulges that project or bulge inwardly.

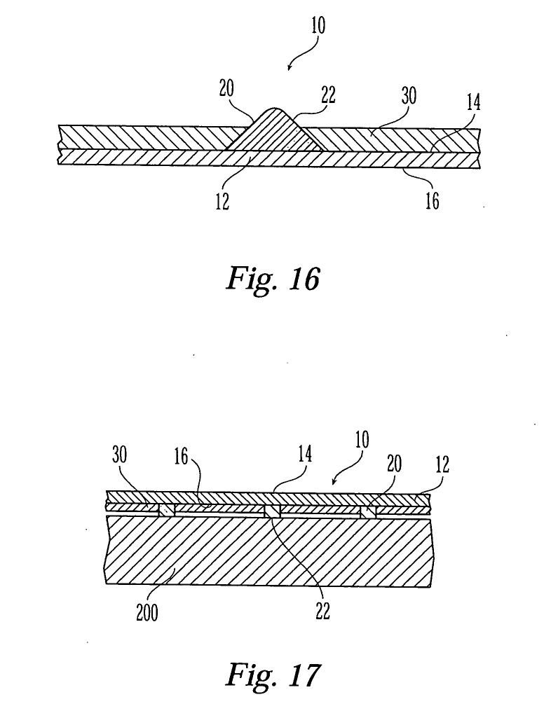

As discussed above, pads or bulges 20 and bearing surfaces 22 may take on many different shapes and profiles. In an exemplary embodiment, as illustrated in FIG. 16, pads 20 have a circular base with bearing surface 22 that creates a triangular profile with a rounded top corner. Pads or bulges 20 having this configuration may have a greater effectiveness in breaking up calcifications along vessel wall 80 and/or in helping to anchor stent in the target area of the vessel lumen. Pads 20 may also have an elongated shape that allows them to connect two adjacent struts 12, in either the radial or axial direction. Pads 20 in this configuration may add to the structural strength of the stent 10 wile protecting the coating simultaneously. Pads 20 may also be formed as projections running substantially over the entire length of the stent 10 Pads 20 in this configuration may assist in the sliding action of a sheath or catheter as it is being pulled back during the delivery of the stent 10.

It should be appreciated that the methods described herein may be used singly or in any combination thereof. Moreover, the present invention is not limited to only the embodiments specifically described herein, and may be used with medical devices other than stents. The disclosed system may be used to deliver a therapeutic agent to various types of body lumina, including but not limited to the esophagus, urinary tract, and intestines. The description contained herein is for purposes of illustration and not for purposes of limitation. Changes and modifications may be made to the embodiments of the description and still be within the scope of the invention. Furthermore, obvious changes, modifications or variations will occur to those skilled in the art. Also, all references cited above are incorporated herein, in their entirety, for all purposes related to this disclosure.

While the foregoing description and drawings may represent preferred embodiments of the present invention, it should be understood that various additions, modifications, and substitutions may be made therein without departing from the spirit and scope of the present invention as defined in the accompanying claims. In particular, it will be clear to those skilled in the art that the present invention may be embodied in other specific forms, structures, arrangements, and proportions, and with other elements, materials, and components, without departing from the spirit or essential characteristics thereof. One skilled in the art will appreciate that the invention may be used with many modifications of structure, arrangement, proportions, materials, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and not limited to the foregoing description.

1. A method of making a stent having at least one strut having an outer surface, and at least one pad that projects from the outer surface of the strut, the method comprising:
(a) obtaining a tube having an outer surface, wherein the tube comprises a tube material;
(b) connecting at least one pad-forming component having an inner surface to the outer surface of the tube, wherein the pad-forming component comprises a component material; and
(c) removing a portion of the tube material from the tube to form the strut;
wherein the at least one pad-forming component forms the at least one pad wherein the at least one pad has a bearing surface.

2. The method of claim 1, further comprising the step of removing a portion of the component material from the pad forming component to form the pad.

3. The method of claim 2, wherein the steps of removing the portion of the tube material and removing the portion of the pad-forming material are conducted simultaneously.

4. The method of claim 1, wherein the pad-forming component is connected to the tube by welding the inner surface of the pad-forming component to the outer surface of the tube.

5. The method of claim 4, wherein the welding is conducted by using a laser.

6. The method of claim 1, wherein the tube is a cylindrical tube.

7. The method of claim 1, wherein the bearing surface is rounded.

8. The method of claim 1, further comprising the step of disposing a therapeutic coating on the outer surface of the strut.

9. The method of claim 8, further comprising the step of disposing the therapeutic coating on the bearing surface of the pad.

10. The method of claim 9, wherein the pad comprises a height and the coating disposed on the outer surface of the strut comprises a thickness, and wherein the pad height is greater than the thickness of the coating disposed on the outer surface of the strut.

11. The method of claim 10, further comprising the step of removing the coating from the bearing surface.

12. The method of claim 11, wherein the coating is removed from the bearing surface by laser ablation.

13. The method of claim 8, wherein the coating comprises paclitaxel.

14. The method of claim 1, wherein the pad-forming component comprises a ring.

15. The method of claim 13, wherein the ring comprises a triangular cross-section.

16. The method of claim 13, wherein the ring comprises a plurality of nodes and connectors.

17. The method of claim 1, further comprising the step of shaping the bearing surface with a laser.

18. The method of claim 1, wherein the pad-forming component comprises a helix.

19. A method of making a stent comprising at least one strut having an inner surface and an outer surface, wherein the strut comprises at least one pad that projects from at least one of the inner surface or the outer surface of the strut, the method comprising:
(a) obtaining a tube having an inner surface, an outer surface, and at least one pad-forming projection integral with and projecting from at least one of the tube inner surface or the tube outer surface; and
(b) forming the strut comprising the pad projecting from at least one of the inner surface or outer surface of the strut, wherein the pad comprises a bearing surface.

20. The method of claim 19, wherein the pad projects from the outer surface of the strut.

21. The method of claim 19, wherein the strut is formed by removing material from the tube with a laser.

22. The method of claim 19, further comprising the step of disposing a therapeutic coating on a surface of the strut from which the pad projects.

23. The method of claim 22, further comprising the step of disposing the therapeutic coating on the bearing surface of the pad.

24. The method of claim 23, wherein the pad comprises a height and the coating disposed on the surface of the strut comprises a thickness, and wherein the pad height is greater than the thickness of the coating disposed on the surface of the strut.

25. The method of claim 24, further comprising the step of removing the coating from the bearing surface.

26. The method of claim 25, wherein the coating is removed from the bearing surface by laser ablation.

27. The method of claim 22, wherein the coating comprises paclitaxel.

28. The method of claim 19, wherein the pad-forming projection is disposed along the longitudinal axis of the tube.

29. A method of making a stent comprising at least one strut having an inner surface and an outer surface, wherein the strut comprises at least one strut bulge that projects towards at least one of the inner surface or the outer surface of the strut, the method comprising:
(a) obtaining a tube having a tubular wall comprising an inner surface and an outer surface, a first end, a second end and a lumen therein;
(b) deforming the tubular wall to form at least one tubular wall bulge extending towards at least one of the tubular wall inner surface or the tubular wall outer surface; and
(c) forming the strut comprising the strut bulge, wherein the strut bulge is at least a portion of the tubular wall bulge and wherein the strut bulge comprises a bearing surface.

30. The method of claim 29, wherein the tubular wall is deformed by using a mold to form the tubular wall bulge.

31. The method of claim 30, wherein the tube is deformed by placing the tube into the mold, which comprises a wall having a contour and exerting a force on the tubular wall to conform the tubular wall to the contour of the mold wall.

32. The method of claim 31, wherein the force is applied to the first end of the tube in a direction parallel to the longitudinal axis of the tube.

33. The method of claim 31, wherein the force is applied to the tubular wall by increasing the pressure within the lumen of the tube.

34. The method of claim 29, wherein the strut is formed by removing material from the tube with a laser.

35. The method of claim 29, further comprising the step of disposing a therapeutic coating on a surface of the strut towards which the bulge projects.

36. The method of claim 35, further comprising the step of disposing the therapeutic coating on the bearing surface of the bulge.

37. The method of claim 36, wherein the bulge comprises a height and the coating disposed on the surface of the strut comprises a thickness, and wherein the bulge height is greater than the thickness of the coating disposed on the surface of the strut.

38. The method of claim 37, further comprising the step of removing the coating from the bearing surface.

39. The method of claim 38, wherein the coating is removed from the bearing surface by laser ablation.

40. The method of claim 35, wherein the coating comprises paclitaxel.
